(19) United States
(12) Patent Application Publication
(10) Pub. No.: US 2024/0409072 A1
(43) Pub. Date: Dec. 12, 2024

(54) CONTROLLER, VEHICLE SYSTEM, VEHICLE AND METHOD FOR OPERATING THE CONTROLLER

(71) Applicant: ZF CV Systems Global GmbH, Bern (CH)

(72) Inventors: Arne Michaelsen, Seelze (DE); Robert Otremba, Ronnenberg (DE); Julian van Thiel, Grossburgwedel (DE)

(21) Appl. No.: 18/810,084

(22) Filed: Aug. 20, 2024

Related U.S. Application Data
(63) Continuation of application No. PCT/EP2023/050279, filed on Jan. 9, 2023.

(30) Foreign Application Priority Data
Feb. 22, 2022 (DE) 10 2022 104 072.0

(51) Int. Cl. B60T 8/173; B60T 8/172

(52) U.S. Cl. CPC B60T 8/173; B60T 8/172; B60T 2270/413; B60T 2270/416

(57) ABSTRACT

A controller is for a vehicle system. The controller includes: at least one terminal for exchanging signals with a peripheral device that is connected to the terminal; a processing unit that is connected or connectable to the at least one terminal and that is configured to process signals that can be transmitted via the terminal; and, at least one operating unit for operating the at least one terminal. The controller has a switch-over unit that is configured to switch over between at least two operating modes for the at least one terminal. The switch-over unit is configured to select the operating mode in dependence upon whether the peripheral device connected to the respective terminal is also simultaneously connected to a further controller via a y-connection, or being directly cabled is connected only to the respective terminal of the controller.

### CROSS-REFERENCE TO RELATED APPLICATIONS

This application is a continuation application of international patent application PCT/EP2023/050279, filed Jan. 9, 2023, designating the United States and claiming priority from German application 10 2022 104 072.0, filed Feb. 22, 2022, and the entire content of both applications is incorporated herein by reference.

### TECHNICAL FIELD

The disclosure relates to a controller, a vehicle system including such a controller, in particular a braking system, a vehicle, in particular a commercial vehicle, and a method for operating the controller.

### BACKGROUND

In vehicles, in particular commercial vehicles having a higher level of automation, in particular level 3 or higher, it has been shown that an improved or extended diagnostic option must be provided if a driver monitoring the driving operation is no longer present to monitor the functionalities of the vehicle, or commercial vehicle. There is already a series of sensors and controllers installed in the vehicle, such that in particular further controllers require additional installation space and also increase both the amount of work required for integration and the costs. Also for actuators, in particular wheel-brake actuators, which in higher levels of automation are likewise redundantly activatable or present, corresponding controllers that allow reliable redundant activation must be provided.

Vehicle systems, in particular electronic braking systems (EBS), generally have a central primary controller that in a normal operating mode generates and outputs electrical brake control signals, in dependence on which brake pressures can be delivered via wheel-brake actuators on a front and a rear main axle of the vehicle. In some cases, a second, secondary controller is used, which in the event of a fault in the central primary controller can maintain an auxiliary, or at least rudimentary, braking operation, which is also referred to as a fail operation braking system (FOBS). When the braking system is in the normal operating mode, the primary controller can generally perform a braking operation, together with vehicle dynamics controls, via the individual wheel-brake actuators on the main axles. In the event of a fault, or when the braking system is in a backup operating mode, vehicle dynamics controls are at least possible to a limited extent. An example of this is described in US 2022/0185251.

To enable the braking operation to be performed in consideration of vehicle dynamics in the respective situations, the controllers make use of sensor signals, in particular wheel-speed signals from wheel-speed sensors assigned to the wheels of the main axle that can be braked. Various cabling options are possible between the sensors and the respective controller, the cabling depending on which sensors are to be available to the respective controller in the normal operating mode, or in the backup operating mode, and how the above-mentioned redundancy is to be realized. Cabling options include, for example, branched cabling via a y-connection, as shown as an example in US 2020/0254986, or unbranched direct cabling. US 2021/0221344 also describes the connecting of a plurality of wheel-speed sensors via a plurality of terminals to an axle modulator that an internal controller and that evaluates the wheel-speed signals.

The cabling of the redundantly present or redundantly activatable actuators, in particular wheel-brake actuators, to the respective controller may also be effected, depending on the wanted functional scope in the normal operating mode and in the backup operating mode, either via branched cabling with a y-connection or by direct cabling, so as to enable the braking operation to be maintained in the respective operating mode.

To enable such sensors or actuators in the vehicle to be operated with the aforementioned controllers in the respective situation (normal operating mode, backup operating mode), the respective controllers must coordinate with each other, in particular to regulate the access authorization. This is important in particular if a sensor or actuator is connected to two different controllers via a y-connection in order to enable redundant access in the event of a fault. In the case of actively operated sensors or actuators that are also supplied with energy by the controllers, it is not possible for two controllers to effect such an energy supply at the same time, such that mutual coordination between the controllers is necessary to enable only the respectively relevant controller to access the sensor, or actuator.

The reading-out of sensors (by measurement of a current) by two controllers at the same time can also result in signal interference, as each of the controllers always has a small amount of feedback to the lines via which the signals are being transmitted. Furthermore, activating of an actuator by two controllers at the same time can also result in interference. Without mutual coordination in consideration of a previously defined access authorization, therefore, the accuracy in the determination of the measurement values of the respective sensor or in the activating of the respective actuator may be impaired. In the case of direct cabling, however, if the respective sensor or the respective actuator is read-out, or activated, by only one controller, there is no such feedback and signal interference, and therefore no mutual coordination is necessary for reading-out, or activating, the respective sensor or actuator.

Therefore, in the designing and configuration of such a fail-operational functioning vehicle system with sensors and/or actuators, a controller type is selected in advance which, depending on the cabling used, enables coordination, or access management, with a further controller of the vehicle system (in the case of use of a y-cabling) or does not enable this (in the case of use of a direct cabling). If the cabling is subsequently changed, the controller must also be retroactively replaced. It is therefore necessary to keep in stock, or store, different controllers, which are selected from the store and then installed depending on the construction and configuration of the vehicle system. This increases the resource requirement involved in storing and configuring such vehicle systems.

### SUMMARY

It is an object of the disclosure to provide a controller that can be used in a flexible, or variable, manner and yet allows reliable operation of a vehicle system. It is also an object of the disclosure to provide a vehicle system, in particular a braking system, a vehicle and a method for operating the controller.

This object is, for example, achieved by a controller, a vehicle system, a vehicle and a method according to the disclosure.

There is accordingly provided a controller for a vehicle system, in particular a braking system in a vehicle, including:
at least one terminal for exchanging signals, for example, sensor signals or actuator signals, and/or preferably also energy, with a peripheral device, for example, a sensor, in particular a wheel-speed sensor, and/or an actuator, in particular a wheel-brake actuator and/or an ABS control valve and/or an axle modulator, that is connected to the terminal;
a processing unit that is connected or connectable to the at least one terminal, wherein the processing unit is configured to generate signals that can be transmitted via the at least one terminal, in particular the above-mentioned actuator signals, and/or to process such signals, for example the sensor signals; and
at least one operating unit for operating the at least one terminal, for example, for performing access management and/or signal interference suppression and/or further functionalities relating to the operation of the respective terminal.

According to the disclosure, the controller also has a switch-over unit, wherein the switch-over unit is configured to switch over between at least two operating modes for the at least one terminal, wherein the switch-over unit is configured to select the operating mode to be set in dependence on whether the peripheral device connected to the respective terminal
is also simultaneously connected to a further controller via a y-connection, whereupon, for example, a first operating mode is selected and set, or
being directly cabled is connected only to the respective terminal of the controller, whereupon, for example, a second operating mode is selected and set.

Additionally provided according to the disclosure are a vehicle system, in particular a braking system, including at least one such controller, a vehicle including the vehicle system, and a method for operating the controller.

Solution according to the disclosure allow the respective controller, or the vehicle system, to be operated in a variable, or flexible and scalable, manner, since, for example, operating units, that is, hardware components of the controller and/or software elements installed on the controller, can be operated in dependence on whether, and/or in which parameterization, they are actually needed for the respective terminal in the implementation of the configuration of the vehicle system. How these operating units are operated is then easily defined by which operating mode is selected and set.

The controller according to the disclosure can thus be set specifically for operation with a y-connection or with direct cabling, preferably on a terminal-by-terminal basis. Thus, for example, operating units in the respective controller may remain permanently turned off, or deactivated, if they are not needed for operation in the current configuration (according to the selected operating mode), and may be activated or enabled accordingly if this is wanted for the operation of the respective vehicle system (according to the selected operating mode), which can be predefined in a correspondingly simple manner by the selection of the respective operating mode.

This is advantageous in particular if sensors are operated as peripheral devices via the respective terminal. The evaluation of sensor signals is usually very complex and sensitive, that is, feedback effects on the respective sensor, caused by parallel accesses from different controllers or by operating units in the controller that are not required or by generalized operating parameters used to operate the operating units, may have negative effects on the signal evaluation. As a result of the corresponding operating mode being set according to the disclosure, interference in this sensitive and complex evaluation of the sensor signals is advantageously suppressed. Sensor operation thus becomes more reliable.

In this way, there is also no need for different controllers to be kept available, as the same stored controller can always be used, regardless of the configuration of the vehicle system, for which the respective operating mode is then switched-over according to the configuration. In addition, terminal-by-terminal switching-over to the respective operating mode provides good scalability and a very high degree of flexibility, as it can be decided individually for each terminal how it is to be operated.

It is preferably provided here that the operating mode to be set can be selected automatically by the switch-over unit, for example in dependence on signals that are transmitted or can be transmitted via the at least one terminal, for example as a result of a signal diagnosis, or the operating mode to be set can be specified manually. Therefore, both a designer and the switch-over unit, or the controller itself, may perform the selection and subsequent switching-over.

It is preferably provided here that the controller is implemented so that it can be parameterized in such a way that how the respective terminal is to be operated by the respective operating unit is assigned in an unambiguous and unalterable manner to each operating mode that can be selected by the switch-over unit. There is therefore no provision for dynamic alteration, that is, for the controller, or the switch-over unit, it is specified in advance, for example via a configuration tool, which operating units are to be controlled with which operating parameters in the respectively selected and set operating mode. The controller cannot change this definition independently and is therefore defined in the operating of the respective terminals.

In addition or alternatively, in this case only operating parameters with which the operating units are operated may be selected, or defined, in dependence on the operating mode selected and set by the switch-over unit for the respective terminal. Thus, for example, individual operating units are relevant for different types of cabling, but these are operated differently, for example with other parameters, in particular other tolerances or value ranges, depending on the type of cabling. In this respect also, it is then preferably provided that the operating parameters with which the operating unit can be operated in the respective operating mode are specified once and/or in a fixed manner for the operating unit, for example before or during the installation of the controller, in particular via a configuration tool. In this way, the operation of the respective terminal is also defined in accordance with a previous parameterization, and cannot be altered dynamically. The definition of the operating parameters may in this case also be effected in dependence on whether it is a sensor or an actuator that is connected as a peripheral device to the respective terminal. Thus, in particular for the complex and sensitive evaluation of sensor signals, different tolerances or value ranges may be useful than for the less sensitive processing of actuator signals. In this respect, the definition of different operating parameters is particularly advantageous in the operation of a sensor at the respective terminal.

It is preferably also provided that the switch-over unit is configured to select the operating mode once for the respective terminal during or after installation of the controller, and to set the selected operating mode so that is unalterable, or dynamically unalterable. It is thereby also defined how the respective terminal is to be operated, which cannot be adjusted by the controller itself.

Only in exceptional cases, for example if the configuration of the vehicle system subsequently changes, for example due to a change in cabling, can the operating mode for the respective terminal be switched back over again if necessary, such that the respective operating unit is then, for example, available again, or is operated under different operating parameters. This, in selected cases, provides for simple adjustment to the respectively changed configuration, without the necessity of replacing the controller.

If the controller according to the disclosure is used with a branching y-connection, in which a plurality of controllers are allowed to access a peripheral device, for example, sensor and/or actuator, it may be necessary, for example, to coordinate the controllers with each other via a corresponding operating unit in the respective controller, which regulates or coordinates access to the respective peripheral device. This is advantageous in particular in the case of a sensor as a peripheral device, as the evaluation of the sensor signals, as already described, is more sensitive and complex than the signal processing for an actuator as a peripheral device, and this evaluation may therefore also be more impaired by uncoordinated simultaneous access by two controllers.

It may thus preferably be provided that the at least one operating unit is an access determination unit and/or an access determination algorithm, wherein the access determination unit and the access determination algorithm are each configured to determine an access authorization, wherein the access authorization indicates whether or not the controller may access, via the respective terminal, a peripheral device, in particular the sensor, connected to the respective terminal, the signals of which are more sensitive and more complex to evaluate. This may preferably be effected via an access circuit which, in dependence on the access authorization, couples the terminal to the peripheral device in a signal-carrying manner, or decouples, or disconnects, them electrically.

It can be defined in a simple manner in this case that the access determination unit and/or the access determination algorithm,
in a first operating mode that can be set by the switch-over unit and in which the peripheral device connected to the respective terminal is simultaneously also connected to a further controller via a y-connection, are/is enabled for operation of the respective terminal, and
in a second operating mode that can be set by the switch-over unit, in which the peripheral device connected to the respective terminal is connected in a directly cabled manner only to the respective terminal of the controller, are/is not enabled for operation of the respective terminal. The resource required for access management can therefore be limited to the respective operating mode in which this access management is actually necessary.

It can preferably further be provided that the access determination unit and/or the access determination algorithm are/is configured to determine the access authorization on the basis of an external status signal and/or an internal status signal, wherein the controller is configured to pick up the external status signal from an external source, and the internal status signal is determined in the controller itself, in particular in the access determination unit and/or by the access determination algorithm. Accordingly, the access management may be effected by a corresponding external signal, which is selectively exchanged, for example, between the respective controllers that seek to access the peripheral device, for example, the sensor or actuator, for coordination purposes, or alternatively by an internal signal evaluation, for example via test pulses or test signals that are emitted or picked up via the respective terminal and from which the access can be deduced.

According to a further embodiment, it is provided that the operating unit is an interference suppression unit for suppressing interference on the signals transmitted via the lines to the respective peripheral device. This may also be operated differently depending on the operating mode, that is, with different operating parameters, in particular since such interference suppression may change in dependence on the type of cabling, in particular with different tolerances and/or value ranges. In particular, the use of such an interference suppression unit may be advantageous in the case of a sensor as a peripheral device, in which case the operating parameters (tolerances and/or value ranges) for the suppression unit may then advantageously be individually adapted for sensitive evaluation.

In the vehicle system according to the disclosure, it may then be additionally provided that the latter has at least two controllers, a primary controller and a secondary controller, wherein the switch-over unit in the respective controller is configured, for the respective terminal, either
to switch over into a first operating mode if a peripheral device connected to the at least one terminal of the primary controller is also simultaneously connected to a terminal of the secondary controller via a y-connection, and
to switch over into a second operating mode if a peripheral device is connected to the at least one terminal of only one controller, the primary controller or the secondary controller, via a directly cabled connection. In this way, in a redundantly implemented vehicle system, for example a braking system, in particular a fail-operational braking system (FOBS), the switchable controller can be used, which is then available at least twice (redundantly) to ensure normal operating mode and backup operating mode of the vehicle system, and which in this case, depending on the redundant terminal type (y-connection or direct cabling to the peripheral device, or sensor/actuator), can be switched over to the respective operating mode, preferably on a terminal-by-terminal basis.

In the method according to the disclosure for operating the controller, it is accordingly provided that, for the at least one terminal, switching-over can be effected between at least two operating modes, wherein the operating mode to be set is selected in dependence on whether the peripheral device connected to the respective terminal
is also simultaneously connected to a further controller via a y-connection, or
being directly cabled is connected only to the respective terminal of the controller.

It is preferably provided in this case that how the respective terminal is operated by the respective operating unit is assigned in an unambiguous and unalterable manner to each selectable operating mode, such that there is no provision for dynamic setting of the operating modes. Preferably, it is then also provided that the operating mode is selected once for the respective terminal during or after the installation of the controller, and the selected operating mode is then set so that it is unalterable. It is only in exceptional situations, for example, if the type of cabling subsequently changes again, that switching-over may be provided.

### BRIEF DESCRIPTION OF DRAWINGS

The invention will now be described with reference to the drawings wherein:

FIGS. 1 and 2 show schematic views of a controller according to the disclosure; and,

FIG. 3 shows a schematic view of a four-axle vehicle having two controllers according to FIG. 1 or FIG. 2.

### DETAILED DESCRIPTION

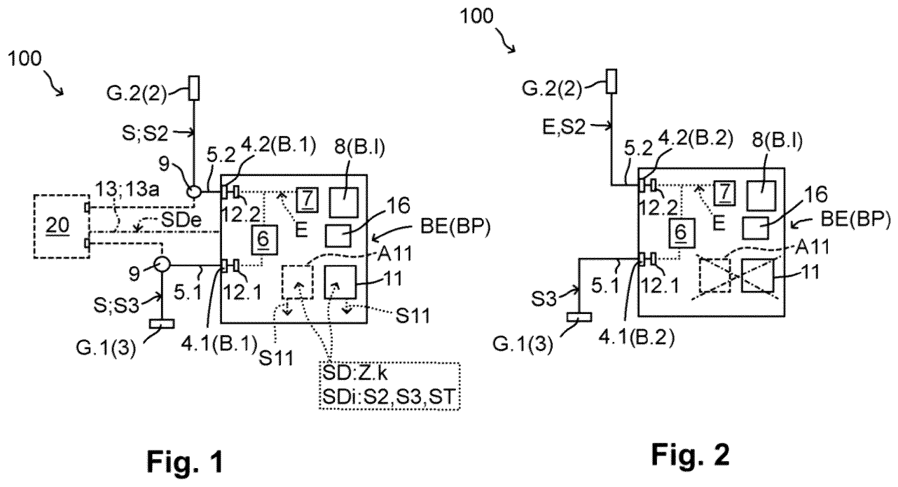

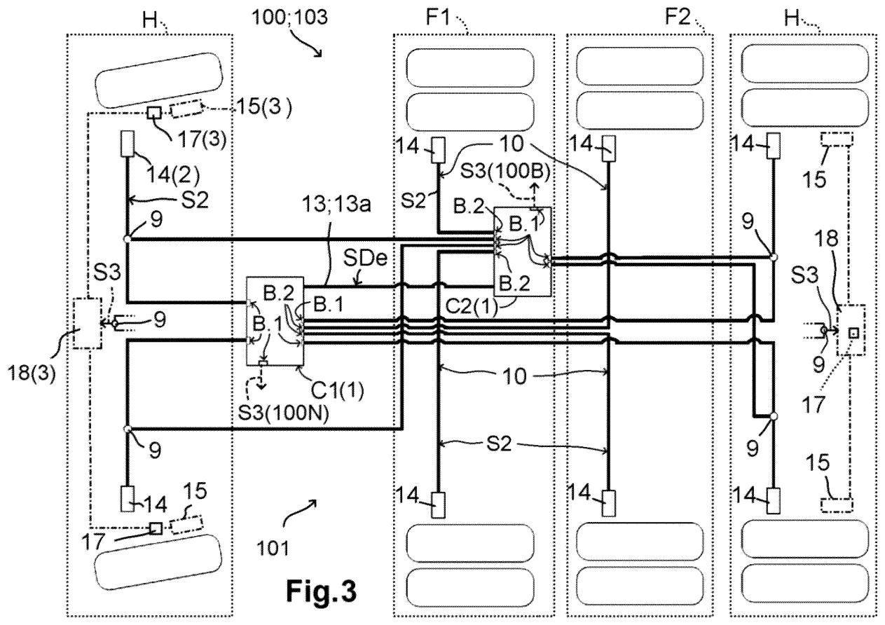

FIG. 1 shows a schematic representation of a controller 1 for a vehicle system 100 of a vehicle 101, for example a braking system 103 represented in FIG. 3, which is configured to operate at least one peripheral device G.i, i=1, . . . . N1 (number of peripheral devices G.i), for example to activate, or read-out, a sensor 2 of the vehicle system 100 and/or to activate at least one actuator 3 of the vehicle system 100. For this purpose, the controller 1 has a plurality of terminals 4.k, k=1, . . . . N2 (number of terminals 4.k) in order to establish a signal-carrying connection to the respective peripheral device G.i, for example, sensor 2 and/or actuator 3, via a line 5.k.

Arranged within the controller 1 there is a processing unit 6, which is configured to generate and/or process signals S, for example, to pick up and process sensor signals S2 from the respective sensor 2 and/or to generate actuator signals S3 for the respective actuator 3 and output them to the latter. Furthermore, depending on the application, there may be provided in the controller 1 an energy supply unit 7 that is configured to generate energy E and provide it, via the terminals 4.k and the lines 5.k, to the peripheral devices G.i, for example, sensors 2 and/or actuators 3. This is relevant in particular for actively operated sensors 2, which for energy supply E draw only from the controller 1 via the lines 5.k, via which the sensor signals S2 are also exchanged. This may also be provided in a comparable manner for the actuators 3, the latter conventionally being supplied with energy E in another way, such that only actuator signals S3 for activating the respective actuator 3 are transmitted via the lines 5.k to the respective actuator 3.

Also arranged in the controller 1A is a switch-over unit 8, which is configured to switch over between different operating modes B.I, I=1, 2, . . . . N3 (number of operating modes B.I). It is preferably provided here that a different operating mode B.I may be set separately for each terminal 4.k, the operating modes B.I differing in respect of which operating unit(s) BE of the controller 1 is/are made available for operating the respective terminal 4.k, and/or which operating parameters BP in the operating unit(s) BE in the controller 1 are employed, or used, for operating the respective terminal 4.k. The respective operating unit BE in this case may be a hardware component in the controller 1 or a software element that is installed on the controller 1. “Make available” here means that the respective operating unit BE is or are enabled or released for use by the respective terminal 4.k via corresponding measures by the switch-over unit 8.

The controller 1, or the switch-over unit 8, is configured so that it can be parameterized accordingly, that is, already at the time of installation of the controller 1 it is specified in a fixed manner for the switch-over unit 8, for example by a configuration tool, which operating unit(s) BE and/or which operating parameters BP are available, or are to be used, in the respectively present operating mode B.I. Specified in a fixed manner in this case means that these specifications no longer alter dynamically during operation of the controller 1, or of the respective vehicle system 100. Thus, if the controller 1 is operated in a particular operating mode B.I due to existing circumstances, the operating unit(s) BE and/or operating parameters BP defined in advance for this operating mode B.I are automatically enabled, or used.

According to an embodiment, the operation of the respective terminal 4.k in a first operating mode B.1 is configured for the use of a y-connection 9, represented in FIG. 1, between the respective terminal 4.k on the controller 1 and the respective peripheral device G.i, for example, sensor 2 or actuator 3, and in a second operating mode B.2 is configured for the use of a directly cabled, unbranched connection 10, represented in FIG. 2, between the respective terminal 4.k on the controller 1 and the respective peripheral device G.i, for example, sensor 2 or actuator 3. In further operating modes B.I that can be set, there may also be defined further conditions or circumstances under which the respective terminal 4.k is to be operated by the respectively enabled or non-enabled operating units BE with the respectively specified operating parameters BP.

In the case of a y-connection 9, the respective peripheral device G.i, for example, the respective sensor 2 or actuator 3, is not only connected to the controller 1, but at the same time also to an additional electronic controller 20, which is not a constituent part of the controller 1, this being effected via a branching line 5.k (y-connection 9), as represented in FIG. 1. In this way, a particular peripheral device G.i, for example, a specific sensor 2 or actuator 3, can interact not only with the controller 1 (primary controller C1, see FIG. 3), but also with a further electronic controller 20 (secondary controller C2, see FIG. 3), for example in the event of a failure of or fault in the controller 1.

However, if the controller 1 and the additional electronic controller 20 both interact simultaneously with the respective peripheral device G.i, for example, the sensor 2 and/or the actuator 3, the signal transmission and/or energy supply may be impaired, thereby rendering the evaluation and/or activation of the respective peripheral device G.i, for example, sensor 2 or actuator 3, unreliable. For secure operation, the controller 1 and the additional electronic controller 20 must therefore coordinate with each other in such a way that only the respectively relevant controller (1, 20) accesses the respective peripheral device G.i, for example, the respective sensor 2 and/or actuator 3, in accordance with predefined rules, and access by the other, non-relevant controller (20, 1) is accordingly prevented, or suppressed.

For this coordination, in the first operating mode B.1 there are/is made available or enabled, as an operating unit BE, inter alia, an access determination unit 11 and/or an access determination algorithm A11, which are each able to decide whether or not the controller 1, as the relevant controller, is authorized to access the respective peripheral device G.i, for example, the respective sensor 2 and/or actuator 3. The presence of an access authorization Z.k for the respective peripheral device G.i, for example, the respective sensor 2 or actuator 3, can then be checked and output, for each terminal 4.k individually, by the access determination unit 11 and/or the access determination algorithm A11.

Depending on this access authorization Z.k, the respective terminal 4.k is then enabled, or activated (access authorization Z.k is present) or deactivated (access authorization Z.k is not present). This may be effected, for example, via an electronic access circuit 12.k, upstream or downstream of the respective terminal 4.k, which is or can be activated in dependence on the access authorization Z.k and which thereupon connects the terminal 4.k, via the line 5.k, to the respective peripheral device G.i, for example, sensor 2 or actuator 3, in a signal-carrying manner, or electrically decouples, or disconnects, it from the latter. In this way, depending on the access authorization Z.k and on a terminal-by-terminal basis, an exchange of the signals S; S2, S3, as well as a supply of energy E, can be allowed or prohibited.

Equally, however, an internal electronic switch arranged respectively in the power supply unit 7 and/or the processing unit 6 may also ensure that, depending on the access authorization Z.k, a sensor signal S2 (no sensor signal S2), or an actuator signal S3 (no actuator signal S3) and/or energy E (no energy E) is transmitted via the terminal 4.k into the line 5.k to the respective peripheral device G.i, for example, sensor 2 or actuator 3.

The access determination unit 11 and/or the access determination algorithm A11 in this case determine/determines the access authorization Z.k in dependence on a status signal SD, from which can be deduced the information as to which controller (1, 20) may or may not access the respective peripheral device G.i, for example, the respective sensor 2 and/or actuator 3. The status signal SD may in this case be an external status signal SDe, which is supplied to the controller 1 from an external source, or an internal status signal SDi, which is determined or generated by the access determination unit 11 and/or by the access determination algorithm A11 in the controller 1 itself.

The external status signal SDe is transmitted, for example, by the electronic controller 20 specifically for mutual coordination via a data connection 13, for example a CAN data bus 13a. The external status signal SDe includes, for example, directly and in any manner, the information as to which controller (1, 20) may or may not access the respective peripheral device G.i, for example, the respective sensor 2 and/or actuator 3, or this information can be deduced at least indirectly from the external status signal SDe (or its absence). Depending on the information transmitted in each case, the respective terminal 4.k may then be enabled, or activated (access authorization Z.k is present), or deactivated (access authorization Z.k is not present), via the electronic access circuit 12.k, via an access signal S11 output by the access determination unit 11 and/or by the access determination algorithm A11.

The internal status signal SDi, on the other hand, is determined or generated by the access determination unit 11 and/or the access determination algorithm A11 itself using its own “observations” relating to the respective terminal 4.k. For this purpose, the access determination unit 11 and/or the access determination algorithm A11 may, for example, briefly and for testing purposes process and analyze, via one of the terminals 4.k, the signals S, for example, the sensor signals S2 and/or actuator signals S3 and/or test signals ST transmitted via the lines 5.k of the respective terminal 4.k. For this purpose, a test pulse may also be sent via the respective terminal 4.k to the respective peripheral device G.i, for example, sensor 2 or actuator 3. The respective terminal 4.k is for this purpose enabled, or activated, at least briefly via the electronic access circuit 12.k.

An access authorization Z.k for a particular terminal 4.k may then result from the fact that the signals S processed for test purposes, for example, sensor signals S2 and/or actuator signals S3 and/or test signals ST, indicate in the current situation that no further electronic controller 20 is accessing the respective peripheral device G.i, for example, the respective sensor 2 or actuator 3, although this would be expected under certain circumstances. The feedback or the signal response is therefore checked for the respective terminal 4.k and, depending on the result, an internal status signal SDi is generated, which then also includes the information as to which controller (1, 20) may or may not access the respective peripheral device G.i, for example, the respective sensor 2 and/or actuator 3. Depending on the information transmitted in each case, the respective terminal 4.k may then be enabled, or activated (access authorization Z.k is present), or deactivated (access authorization Z.k is not present), via the electronic access circuit 12.k, via the access signal S11 output by the access determination unit 11 and/or the access determination algorithm A11.

The first operating mode B.1, which is provided for the y-connection 9 described, is thus characterized by the fact that those operating units BE, that is, hardware components and/or software elements, that are necessary for the access management described above are enabled for reliable, or undisturbed operation, of the respective terminal 4.k.

In addition, there may also be provided in the controller 1 an interference suppression unit 16, as an operating unit BE, which in the first operating mode B.1, due to the use of the y-connection 9 for the respective terminal 4.k, is operated with different operating parameters PB than in the case of use of a directly cabled connection 10. The interference suppression unit 16 provides interference suppression of the transmitted signals S, in particular sensor signals S2 and/or actuator signals S3. Here, such interference suppression is effected differently in the case of a y-connection 9 than in the case of a directly cabled connection 10, such that in the first operating mode B.1, different fixed preset operating parameters BP are used for the interference suppression unit 16 than in the second operating mode B.2.

The second operating mode B.2, which is configured for the directly cabled connection 10 according to FIG. 2, is also characterized by the fact that the extensive access management described above is not necessary. This follows from the fact that the respective peripheral device G.i, for example, the respective sensor 2 or actuator 3, interacts permanently with only one controller 1, and therefore no interference with the signal and/or energy transmission by a further electronic device 20 is to be expected. Accordingly, the respective operating units BE, that is, hardware components and/or software elements that are necessary for access management, are deactivated, or not enabled or not released, and the respective terminal 4.k is thus granted permanent access to the respective peripheral device G.i, for example, the respective sensor 2 and/or actuator 3. The suppression unit 16 is also operated with the operating parameters BP specified for the second operating mode B.2.

The switch-over, via the switch-over unit 8, into the respective operating mode B.I may in this case be effected, for example, after installation, that is, after it has been defined whether a y-connection 9 or a directly cabled connection 10 is present at the respective terminal 4.k. The operating mode B.I that is then set is then no longer altered dynamically, as the type of cabling (9, 10) at the respective terminal 4.k normally does not alter either.

The operating mode B.I to be set may be transmitted to the switch-over unit 8 by an operator. Alternatively (or additionally), however, the switch-over unit 8 may itself establish which operating mode B.I is to be set, that is, in the above example the first operating mode B.1 or the second operating mode B.2. This may be effected in a similar way to the access management in that the respective terminal 4.k is “observed”, preferably immediately after installation, when it is assumed that the components of the respective vehicle system 100 have full functional capability. For this purpose, the switch-over unit 8 may, for example, briefly and for testing purposes process and analyze, via the respective terminal 4.k, the signals S, for example, the sensor signals S2 and/or actuator signals S3 and/or test signals ST transmitted via the lines 5.k of the respective terminal 4.k. For this purpose, a test pulse may also be sent via the respective terminal 4.k to the respective peripheral device G.i, for example, sensor 2 or actuator 3. Depending on the type of cabling, the switch-over unit 8 will then “observe” a different reaction and from this can deduce the type of cabling and then automatically set the corresponding operating mode B.I permanently.

In this way, the same controller 1 may be used for different types of cabling and switched over into the different operating modes B.I in dependence on the parameters. The ability to switch over into the respective operating mode B.I for each terminal individually allows the controller 1 to be used in a variable manner.

In particular, it is provided in this case that such a controller 1 is used in at least two implementations in a vehicle system 100 that is operated in a fault-tolerant or fail-operational functioning manner, for example in a braking system 103, in particular a fail operation braking system (FOBS), as represented by way of example in FIG. 3. For this purpose, it may be defined that when the vehicle system 100 is in a normal operating mode 100N, the controller 1 described above is used as a primary controller C1, which in normal operating mode 100N operates the peripheral devices G.i, for example, sensors 2, for example wheel-speed sensors 14, and actuators 3, for example wheel-brake actuators 15 and/or ABS control valves 17 and/or axle modulators 18. In the event of a fault, a secondary controller C2 is used as an additional electronic controller 20, which has the same function as the controller 1 described above. When the vehicle system 100 is in a backup operating mode 100B, the secondary controller C2 is then likewise able to operate at least some of the peripheral devices G.i, for example, sensors 2, for example the wheel-speed sensors 14 at least on a main axle H of the vehicle 101, and actuators 3, for example wheel-brake actuators 15 and/or ABS control valves 17 and/or axle modulators 18 at least on the main axle H of the vehicle 101.

The respective controller C1, C2 is thus able to generate the actuator signals S3 (brake control signals) in dependence on the sensor signals S2 available in the respective operating mode 100N, 100B and, in dependence thereon, to activate the respective actuators 3 as peripheral devices G.i, for example, wheel-brake actuators 15 and/or ABS control valves 17, which may also be effected indirectly, for example via a pressure modulator, or axle modulator 18, that processes the actuator signals S3 and in which the ABS control valves 17 may also be integrated, as represented for the rear main axle H in FIG. 3. Since in both cases the peripheral devices G.i, that is, sensors 2 and actuators 3, can be used on the main axles H, dynamic driving control based on the sensor signals S2 sensed from all wheels of the main axles H can be maintained both in the normal operating mode 100N by the primary controller C1 and in the event of a failure of the primary controller C1, that is, in the event of a fault, or in backup operating mode 100B, by the still functioning secondary controller C2. The secondary controller C2 can thus continue to provide at least rudimentary braking functions in consideration of the driving dynamics in this redundant fallback level.

The primary and secondary controllers C1, C2 then intermittently exchange external status signals SDe, via the data connection 13, in order to derive the information about the current situation from which the normal operating mode 100N or the backup operating mode 100B follows. However, in a vehicle system 100 without such a data connection 13 or in the absence thereof, the described internal status signals SDi may also be used.

Since, in the embodiment of the vehicle system 100 shown, the peripheral devices G.i, that is, sensors 2 and actuators 3, which are each located on the main axle H of the vehicle 101, are connected to both the primary and the secondary controller C1, C2 via a y-connection 9, the respective terminals 4.k to these peripheral devices G.i, that is, sensors 2 and actuators 3, are in both controllers C1, C2 each operated in the first operating mode B.1, which is set accordingly via the switch-over unit 8. As described above, the corresponding operating units BE, that is, hardware components and/or software elements, which can provide coordinated operation of the respective terminal 4.k in the respective controller C1, C2, are thus made available. Additionally, for the respective operating units BE in the primary controller C1 and secondary controller C2, which operate the respective terminal 4.k in the first operating mode B.1, for example, for the interference suppression unit 16, the operating parameters BP that are specified in a fixed manner for the first operating mode B.1 are used.

According to FIG. 3, additionally, sensors 2 as peripheral devices G.i, for example wheel-speed sensors 14, which are located on a first and a second additional axle F1, F2 of the vehicle 101, are each connected by directly cabled connection 10 to only one of the two controllers C1, C2. The terminals 4.k on the primary controller C1, which are connected to the sensors 2 as peripheral devices G.i, for example wheel-speed sensors 14, on the second additional axle F2 of the vehicle 101, are accordingly operated in a second operating mode B.2, as are the terminals 4.k on the secondary controller C2, which are connected to the sensors 2, for example wheel-speed sensors 14, on the first additional axle F1 of the vehicle 101. Accordingly, these do not require mutual coordination between the controllers C1, C2, such that the respective operating units BE, that is, hardware components and/or software element that regulate the access management for the respective terminal 4.k in the respective controller C1, C2, do not have to be made available, or enabled. Additionally, for the respective operating units BE in the primary controller C1 and secondary controller C2, which operate the respective terminal 4.k in the second operating mode B.2, for example, the interference suppression unit 16, the operating parameters that are specified in a fixed manner for the second operating mode B.2, are used.

Accordingly, in the present case a mixed operation of the two controllers C1, C2 is made possible in that different terminals 4.k of the same controller C1, C2 are operated in different operating modes B.I. The sensor signals S2 from the sensors 2 on the first additional axis F1 may also be used in the normal operating mode 100N for a corresponding operation of the vehicle system 100, in that they are transmitted, for example via the data connection 13, to the primary controller C1 and processed centrally therein together with further sensor signals S2. In addition, an extended functionality can then be provided via the sensors 2 on the additional axles F1, F2, both in the normal operating mode 100N and in the backup operating mode 100B. No further controller 1 is required for this, but the existing terminals 4.k can be utilized optimally and reliably by switching over into the respective operating mode B.I. Overall, therefore, variable or flexible operation with a high functional scope can be achieved.

It is understood that the foregoing description is that of the preferred embodiments of the invention and that various changes and modifications may be made thereto without departing from the spirit and scope of the invention as defined in the appended claims.

### LIST OF REFERENCE DESIGNATIONS (CONSTITUENT PART OF THE DESCRIPTION)

1 controller
2 sensor
3 actuator
4.k k terminal
5.k lead to k terminal
6 processing unit
7 energy supply unit
8 switch-over unit
9 y-connection
10 unbranched connection
11 access determination unit
12.k access circuit for the k terminal
13 data connection
13a CAN data bus
14 wheel-speed sensor
15 wheel-brake actuator
16 interference suppression unit
17 ABS control valve
20 additional electronic controller
100 vehicle system
100N normal operating mode of the vehicle 100
100B backup operating mode of the vehicle 100
101 vehicle
103 braking system
A11 access determination algorithm
B.I first operating mode
BE operating unit
BP operating parameter
C1 primary controller
C2 secondary controller
E energy
F1 first additional axle
F2 second additional axle
G.i first peripheral device
H main axle of the vehicle 101
N1 number of peripheral devices G.i
N2 number of terminals 4.k
N3 number of operating modes B.I
S signal
SD status signal
SDe external status signal
SDi internal status signal
ST test signal
S2 sensor signal
S3 actuator signal
S11 access signal
Z.k access authorization for the k terminal 4.k
i,k,l, indices

1. A controller for a vehicle system, the controller comprising:
at least one terminal for exchanging signals with a peripheral device that is connected to a said at least one terminal;
a processing unit connected or configured to be connected to said at least one terminal, wherein said processing unit is configured to process signals that can be transmitted via said at least one terminal;
at least one operating unit for operating said at least one terminal; and,
a switch-over unit configured to switch over between at least two operating modes for said at least one terminal, wherein said switch-over unit is configured to select one operating mode of said at least two operating modes in dependence upon whether the peripheral device connected to a respective terminal of said at least one terminal:
is also simultaneously connected to a further controller via a y-connection, or
being directly cabled, is connected only to said respective terminal of said at least one terminal of the controller.

2. The controller of claim 1, wherein said switch-over unit is configured to select said one operating mode of said at least two operating modes once for said respective terminal of said at least one terminal during or after installation of the controller and to set the selected operating mode so that said one operating mode is unalterable.

3. The controller of claim 1, wherein the controller has a plurality of said terminals; and, said switch-over unit is configured to select one of said at least two operating modes separately for each of said plurality of terminals and to switch over into said one operating mode selected for each of said plurality of terminals.

4. The controller of claim 1, wherein said at least one operating unit is configured to operate said respective terminal of said at least one terminal in dependence on said one operating mode selected and set by said switch-over unit.

5. The controller of claim 4, wherein the controller is implemented to be parameterized such that how said respective terminal is to be operated by said at least one operating unit is assigned in an unambiguous and unalterable manner to each of said at least two operating modes that can be selected by said switch-over unit.

6. The controller of claim 4, wherein said switch-over unit is configured to either enable or not enable said at least one operating unit in dependence upon the selected and set one of said at least two operating modes for the operation of said respective terminal of said at least one terminal.

7. The controller of claim 4, wherein said at least one operating unit is configured to be operated in dependence upon specified operating parameters; and, said operating parameters for said at least one operating unit are selected in dependence upon said one of said at least two operating modes selected and set by said switch-over unit for said respective terminal of said at least one terminal.

8. The controller of claim 7, wherein said operating parameters, with which said at least one operating unit is configured to be operated in said one of said at least two operating modes, are specified once and/or in a fixed manner for said at least one operating unit.

9. The controller of claim 7, wherein said operating parameters, with which said at least one operating unit is configured to be operated in said one of said at least two operating modes, are specified once and/or in a fixed manner for said at least one operating unit before or during an installation of the controller.

10. The controller of claim 4, wherein said at least one operating unit for said respective terminal of said at least one terminal is configured to be operated in said one of said at least two operating modes selected and set in dependence upon whether the peripheral device is a sensor or an actuator; and, said processing unit is configured to at least one of generate signals and process sensor signals.

11. The controller of claim 10, wherein at least one of:
said signals generated by said processing unit are at least one of actuator signals for actuating at least one of the actuator, an ABS-control valve, and an axle modulator; and,
said sensor signals are wheel-speed sensor signals.

12. The controller of claim 11, wherein the actuator is a wheel-brake actuator.

13. The controller of claim 4, wherein said at least one operating unit is at least one of an access determination unit and an access determination algorithm; said at least one of the access determination unit and the access determination algorithm is configured to determine an access authorization; and, wherein said access authorization indicates whether or not the controller may access, via said respective terminal, a peripheral device that is connected to said respective terminal.

14. The controller of claim 13, wherein said at least one of said access determination unit and said access determination algorithm is configured to determine said access authorization on a basis of at least one of an external status signal and an internal status signal; and, the controller is configured to pick up the external status signal from an external source, and said internal status signal is determined in the controller.

15. The controller of claim 14, wherein said internal status signal is determined at least one of in said access determination unit and by the access determination algorithm.

16. The controller of claim 13, wherein said at least one of said access determination unit and said access determination algorithm is configured to:
in a first operating mode that can be set by said switch-over unit and in which the peripheral device connected to said respective terminal is simultaneously also connected to a further controller via a y-connection, enable operation of said respective terminal; and,
in a second operating mode that can be set by said switch-over unit in which the peripheral device connected to said at least one terminal is connected in a directly cabled manner only to said respective terminal of the controller, not enable operation of said respective terminal.

17. The controller of claim 16, wherein the peripheral device is a sensor.

18. The controller of claim 13, wherein the peripheral device is a connected sensor.

19. The controller of claim 4, wherein said at least one operating unit is an interference suppression unit for suppressing interference on said signals transmitted via lines to the respective peripheral device.

20. The controller of claim 19, wherein said signals are sensor signals.

21. The controller of claim 1, wherein said one of said at least two operating modes to be set is configured to be selected automatically by said switch-over unit or said one of said at least two operating modes to be set can be specified manually.

22. The controller of claim 1, wherein said one of said at least two operating modes to be set is configured to be selected automatically by said switch-over unit in dependence upon signals that are transmitted or can be transmitted via said at least one terminal.

23. The controller of claim 1, wherein the vehicle system is a braking system.

24. A vehicle system comprising:
at least one peripheral device configured to at least one of transmit or receive signals;
at least one controller including at least one terminal for exchanging signals and a processing unit connected or configured to be connected to said at least one terminal, wherein said processing unit is configured to process signals that can be transmitted via said at least one terminal;
said at least one controller further including at least one operating unit for operating said at least one terminal and a switch-over unit configured to switch over between at least two operating modes for said at least one terminal;
said at least one controller being connected to said at least one peripheral device via a directly cabled connection or connected via an additional y-connection for transmitting the signals;
said switch-over unit in said at least one controller being configured to select one of said at least two operating modes in dependence upon whether said at least one peripheral device connected to a respective terminal of said at least one terminal is:
also simultaneously connected to a further controller of the vehicle system via the y-connection, or
directly cabled and connected only to said respective terminal of said controller.

25. The vehicle system of claim 24, wherein said at least one peripheral device is at least one of a sensor and an actuator.

26. The vehicle system of claim 24, wherein said at least one peripheral device is at least one of a wheel-brake actuator, an ABS control valve, and an axle modulator.

27. The vehicle system of claim 24, wherein the vehicle system has at least two of said at least one controller including a primary controller and a secondary controller; wherein said switch-over unit in corresponding ones of said at least two controllers is configured for a corresponding one of said at least one terminal to either:
switch over into a first operating mode of said at least two operating modes if said at least one peripheral device connected to said at least one terminal of the primary controller is also simultaneously connected to said at least one terminal of said secondary controller via a y-connection; and,
switch over into a second operating mode if said at least one peripheral device is connected to said at least one terminal of only one of said primary controller and said secondary controller via a directly cabled connection.

28. The vehicle system of claim 24, wherein the vehicle system is a braking system.

29. The vehicle system of claim 27, wherein said at least one peripheral device is a sensor.

30. A vehicle comprising the vehicle system of claim 24.

31. A method for operating a controller having at least one terminal, wherein, via the at least one terminal, signals are transmitted from or to a peripheral device connected to the terminal, the method comprising:
at least one of processing signals picked up via the at least one terminal in the controller and generating signals output via the at least one terminal; wherein the at least one terminal is configured to be operated via at least one operating unit;
effecting, for the at least one terminal, a switching-over between at least two operating modes, wherein an operating mode to be set is selected in dependence upon whether the peripheral device connected to a respective terminal of the at least one terminal is:
also simultaneously connected to a further controller via a y-connection, or
directly cabled and connected only to said respective terminal of the controller.

32. The method of claim 31, wherein how the respective terminal operated by the respective operating unit of said at least one operating unit is assigned in an unambiguous and unalterable manner to each selected operating mode.

33. The method of claim 31, wherein the at least one operating unit is at least one of:
either enabled or not enabled for the operation of the respective terminal in dependence upon the selected and set operating mode; and,
operated in dependence upon specified operating parameters, wherein the operating parameters are specified in dependence upon the operating mode selected and set by the switch-over unit for the respective terminal.

34. The method of claim 33, wherein the operating parameters are at least one of specified once and specified fixedly for the at least one operating unit.

35. The method of claim 34, wherein the operating parameters are specified before or during installation of the controller.

36. The method of claim 31, wherein the operating mode is selected once for the respective terminal during or after installation of the controller, and the selected operating mode is then set so that it is unalterable.
